(19) United States
(12) Patent Application Publication
(10) Pub. No.: US 2008/0145180 A1
(43) Pub. Date: Jun. 19, 2008

(54) Combination of a screw member and a sleeve and also a method of producing such a combination

(75) Inventors: Matthias Hermann, Munchen (DE); Carsten Baelum, Grunwald (DE)

Correspondence Address: Edward J. Timmer, P.O. Box 770, Richland, MI, 49083, US

(73) Assignee: ElringKlinger AG

(21) Appl. No.: 11/973,517

(22) Filed: Oct. 9, 2007

Related U.S. Application Data
(63) Continuation of application No. PCT/EP2006/010068, filed on Oct. 19, 2006.

(51) Int. Cl. F16B 29/00; F16B 35/00; F16B 39/26; B23P 11/00

(52) U.S. Cl. 411/378; 470/3

(57) ABSTRACT

In order to provide a combination of a screw member comprising a screw head, a threaded portion and a shank portion which is arranged between the screw head and the threaded portion and has an external diameter that is smaller than the external diameter of the threaded portion, and also a sleeve which incorporates a narrowed section the internal diameter of which is smaller than the external diameter of the threaded portion, whereby said combination is producible in a simple manner but nevertheless ensures that the sleeve is held securely on the screw member, it is proposed that the sleeve be in multipart form at least in the narrowed section thereof, that the shank portion of the screw member be passed through the narrowed section of the sleeve and that the several parts of the sleeve be connected to one another in such a manner that the sleeve is held captive on the screw member.

### RELATED APPLICATION

The present disclosure relates to the subject-matter which was disclosed in the international patent application No. PCT/EP2006/010068 dated 19 Oct. 2006. The entire description of this earlier application is incorporated by reference thereto as a constituent part of the present description (“incorporation by reference”).

### FIELD OF DISCLOSURE

The present invention relates to a combination of a screw member comprising a screw head, a threaded portion and a shank portion which is arranged between the screw head and the threaded portion and has an external diameter that is smaller than the external diameter of the threaded portion, and a sleeve which has a narrowed section the internal diameter of which is smaller than the external diameter of the threaded portion.

### BACKGROUND

Such a combination is known from DE 199 24 502 C2. In this known combination, the narrowed section is formed in a washer connected to the sleeve. The washer and/or the sleeve are slit so that the sleeve and/or the washer expand when slipping the narrowed section formed by the washer over the threaded portion of the screw member and then snap back again after the narrowed section has been pushed completely over the threaded portion.

The washer and the sleeve are held captive on the screw member once they have snapped back.

A further combination of a screw member and a washer together with a sleeve which are held captive on the screw member is known from DE 195 10 349 A1. In an embodiment of this combination, the sleeve is provide with embossments after the insertion of the screw member and these form a narrowed section therein by means of which the sleeve is held captive on the screw member.

For this purpose however, an additional embossing process is necessary after the screw member has been inserted into the sleeve.

### SUMMARY OF THE INVENTION

The object of the present invention is to provide a combination of the type mentioned hereinabove which is producible in a simple manner but which nevertheless ensures that the sleeve is held securely on the screw member.

In accordance with the invention, this object is achieved in the case of a combination comprising the features indicated in the preamble of claim 1 in that the sleeve is in multipart form at least in the narrowed section thereof, in that the shank portion of the screw member passes through the narrowed section of the sleeve and in that the several parts of the sleeve are connected to one another in such a manner that the sleeve is held captive on the screw member.

The concept underlying the present invention is that of building up at least the narrowed section of the sleeve from a plurality of sleeve parts which can be advanced towards the screw member in a direction that is transverse to the longitudinal axis of the screw member and then interconnected in order to form a narrowed section representing an undercut.

Hereby, the sections of the several sleeve parts forming the narrowed section may already be formed on the sleeve parts before arranging the sleeve parts on the screw member so that it is no longer necessary to subject the sleeve to a shaping process after the sleeve parts have been arranged on the screw member.

In a preferred embodiment of the invention, provision is made for the sleeve to be in two-part form at least in the narrowed section thereof.

In particular, provision may be made for each part of the sleeve to extend over a peripheral angle of approximately 180°. In this case, each sleeve part forms one half of the sleeve.

In order to prevent the several parts of the sleeve from moving apart, it is of advantage if the combination further comprises a ring-shaped element which surrounds the several parts of the sleeve.

This ring-shaped element can be held on the sleeve in force-locking and/or positive manner.

The ring-shaped element can be in the form of a resilient element in order to provide a vibration decoupling means between the combination consisting of a screw member and a sleeve and the components that are to be connected together by the combination.

The ring-shaped element can, in particular, comprise an elastomer material.

Furthermore, in a preferred embodiment of the invention, provision is made for the screw head end portion of the sleeve to comprise a radially outwardly projecting flange. Such a flange can serve, in particular, as a bearing surface for the screw head of the screw member so that the sleeve can simultaneously adopt the function of a washer.

Furthermore, provision may be made for the end portion of the sleeve remote from the screw head to have a radially outwardly projecting flange. Such a radially outwardly projecting flange can serve, in particular, as an undercut which retains the ring-shaped element on the sleeve in positive manner.

In a preferred embodiment of the invention, provision is made for the sleeve to be provided with a radially outwardly projecting flange in the narrowed section thereof.

It is particularly expedient if the plurality of parts of the sleeve are individual parts which are completely separate from one another.

Preferably, the sleeve is divided into several parts over the entire longitudinal direction thereof.

In a preferred embodiment of the invention, the combination does not comprise a washer produced separately from the sleeve.

Furthermore, the present invention relates to a method of making a combination of a screw member comprising a screw head, a threaded portion and a shank portion which is arranged between the screw head and the threaded portion and has an external diameter that is smaller than the external diameter of the threaded portion, and

a sleeve incorporating a narrowed section the internal diameter of which is smaller than the external diameter of the threaded portion.

The further object of the present invention is to provide a method of producing such a combination which can easily be carried out and leads to the sleeve being held securely on the screw member.

In accordance with the invention, this object is achieved by a method which comprises the following method steps:
providing a sleeve which is in multipart form at least in the narrowed section thereof;
arranging the several parts of the sleeve on the screw member in such a manner that the shank portion of the screw member passes through the narrowed section of the sleeve;
connecting the several parts of the sleeve to one another in such a manner that the sleeve is held captive on the screw member.

Furthermore, in a preferred embodiment of this method, a ring-shaped element is pushed onto the sleeve in such a manner that it surrounds the several parts of the sleeve and thereby connects the several parts of the sleeve together and prevents them from moving away from the screw member.

Further features and advantages of the invention form the subject matter of the following description and the graphical illustration of an exemplary embodiment.

### BRIEF DESCRIPTION OF THE DRAWINGS

FIG. 1 shows a schematic sectional view through an assembly consisting of a first component and a second component which are fixed together by means of a screw member having a sleeve that is held captive on the screw member and are mutually decoupled from vibration by means of elastomer elements;

FIG. 2 a schematic longitudinal sectional view through the screw member comprising a sleeve and an elastomer element depicted in FIG. 1; and

FIG. 3 a schematic perspective illustration of the assembly of the combination of the screw member, the sleeve and the elastomer element.

Similar or functionally equivalent elements are designated by the same reference symbols in each of the Figures.

### DETAILED DESCRIPTION OF THE INVENTION

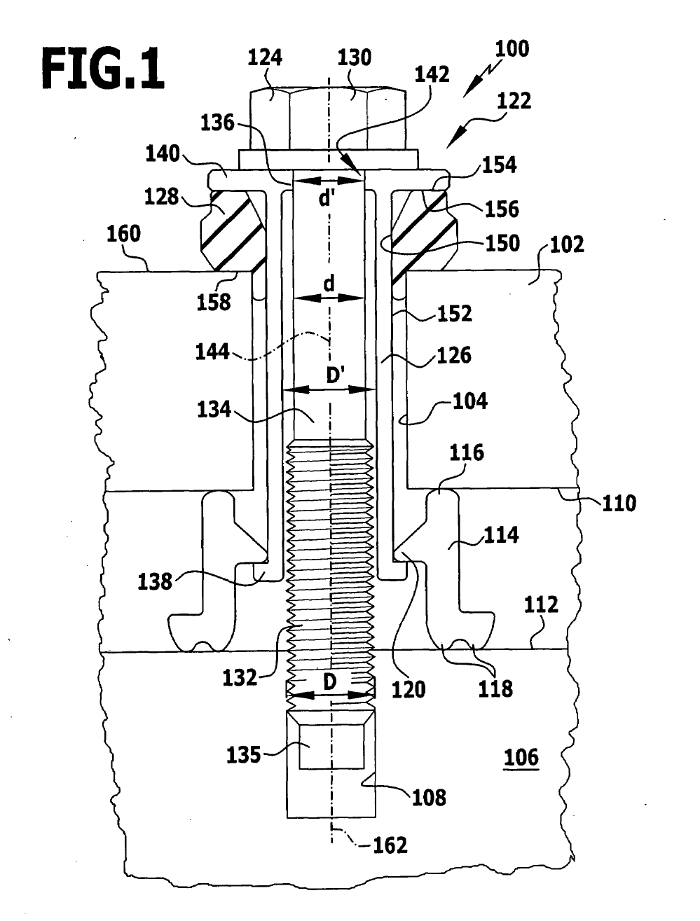

An assembly bearing the general reference 100 which is illustrated in sectional manner in FIG. 1 comprises a first component 102 having a substantially cylindrical passage opening 104, a second component 106 having a threaded blind hole 108, a ring-shaped elastomer sealing element 114 comprising an upper sealing lip 116 and lower sealing lips 118 arranged between a lower surface 110 of the first component 102 and an upper surface 112 of the second component 106 and also a flange 120 projecting radially into the interior of the elastomer sealing element 114, and a combination 122 consisting of a screw member 124, a sleeve 126 held captive on the screw member 124, and a ring-shaped element 128 surrounding the screw-head-end end portion of the sleeve 126 in ring-like manner which is fixed to the sleeve 126 in force-locking and/or positive manner.

The screw member 124 comprises a screw head 130 which may be in the form of a hexagonal screw head for example, a threaded portion 132 having an external diameter D, a shank portion 134 which is arranged between the threaded portion 132 and the screw head 130 and has an external diameter d that is smaller than the external diameter D of the threaded portion 132, and an end portion 138 which adjoins the end of the threaded portion 134 remote from the screw head 130 and has an external diameter that is smaller than the external diameter D of the threaded portion 134 and smaller than the external diameter d of the shank portion 134 of the screw member 124.

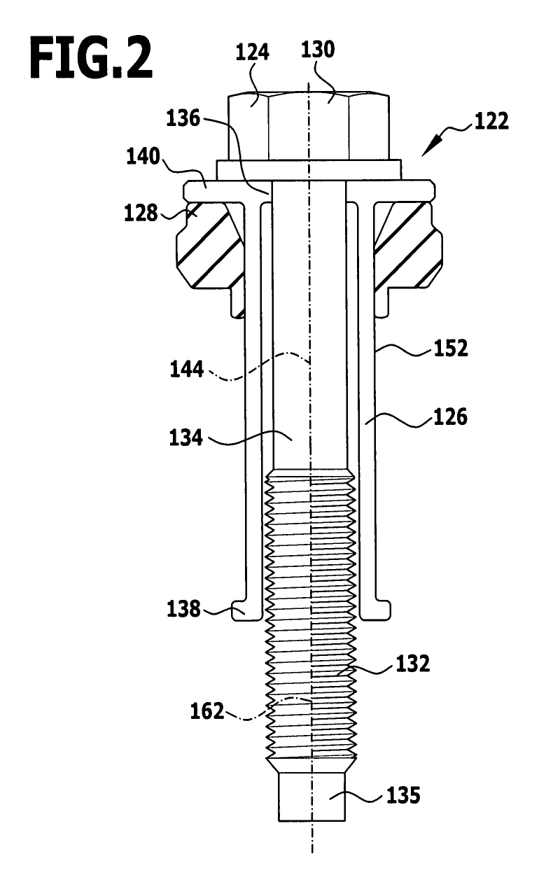

As can best be seen from FIGS. 1 and 2, the sleeve 126 is of hollow cylindrical shape and is provided at the screw head end thereof with an outer screw-head-end flange 140 that projects outwardly in the radial direction and an inner screw-head-end flange 136 that projects inwardly in the radial direction and, at the end thereof remote from the screw head 130, it is provided with a threaded-portion flange 138 that projects outwardly in the radial direction.

The sleeve 126 has an internal diameter D′ which is slightly greater than the external diameter D of the threaded portion 132 of the screw member 124. Due to the inner screw-head-end flange 136, there is formed in the interior of the sleeve 126 a narrowed section 142 whereat the sleeve 126 has a reduced internal diameter d′ which is slightly greater than the external diameter d of the shank portion 134 of the screw member 124 and is smaller than the external diameter D of the threaded portion 132 of the screw member 124 so that the threaded portion 132 cannot be moved through the narrowed section 142 of the sleeve 126.

In order nonetheless to enable the sleeve 126 to be arranged on the screw member 124 in such a manner that the shank portion 134 of the screw member 124 passes through the narrowed section 142 of the sleeve 126, the sleeve 126 is sub-divided along one of the longitudinal central planes thereof which run through the longitudinal central axis 144 of the sleeve 126 into two sleeve parts 146a, 146b which are formed separately from one another and can be assembled together for forming the complete sleeve 126, whereby they rest against one another at the contact surfaces 148 which are aligned in parallel with said longitudinal central plane of the sleeve 126.

The two sleeve parts 146a, 146b each extend over a peripheral angle of 180° and are of mutually identical construction, whereby the number of different components required for the combination 122 is reduced.

The sleeve parts 146a, 146b and the screw member 124 are preferably formed from a metallic material, and in particular from a steel material.

The ring-shaped element 128 is preferably formed from a resilient material, from an elastomer material for example.

As can best be seen from FIG. 1, the ring-shaped element 128 has an inner contact surface 150 for application to the outer surface 152 of the sleeve 126, a flat screw-head-end contact surface 154 for application to the lower surface 156 of the outer screw-head-end flange 140 of the sleeve 126, and a component contact surface 158 that is remote from the outer screw-head-end flange 140 for application to an upper surface 160 of the first component 102.

The screw-head-end upper region of the inner surface of the ring-shaped element 128 is chamfered so that the interior space surrounded by the ring-shaped element 128 flares, conically for example, towards the screw-head-end contact surface 154. This flaring of the interior space of the ring-shaped element 128 makes it easier to pull the ring-shaped element 128 over the threaded-portion flange 138 of the sleeve 126 as will subsequently be explained.

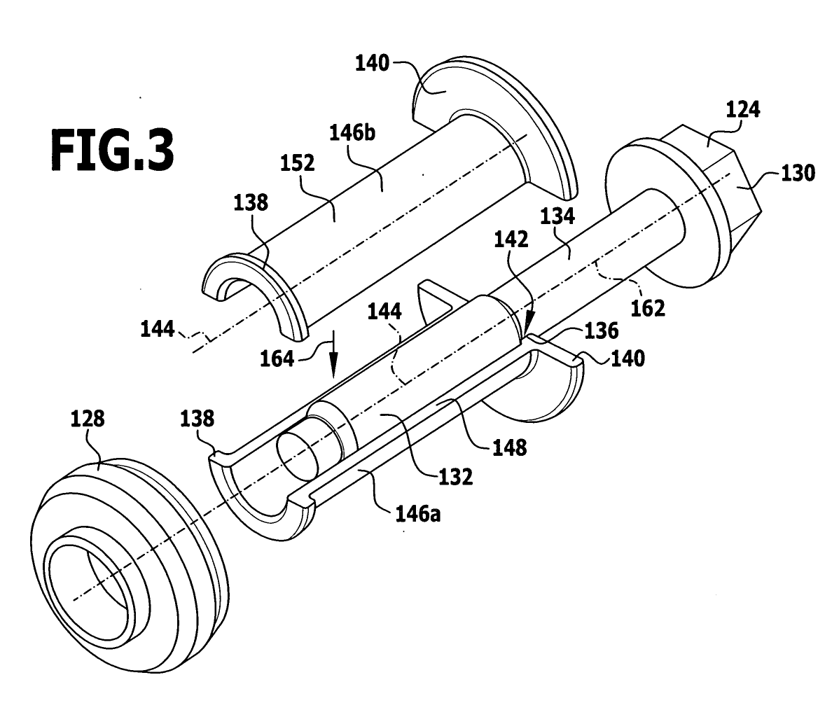

In order to produce the combination 122 consisting of the screw member 124, the sleeve 126 held captive on the screw member 124 and the ring-shaped element 128, one proceeds as follows (see FIG. 3):

Firstly, the screw member 124 is inserted into the first sleeve part 146a in such a way that the shank portion 134 of the screw member 124 comes to rest in the narrowed section 142 of the first sleeve part 146a.

Thereafter, the second sleeve part 146b is placed on the first sleeve part 146a in a direction 164 running perpendicularly to the longitudinal axis 162 of the screw member 124 in such a way that the contact surfaces 148 of the two sleeve parts 146a, 146b coincide and come together, and the two complementary sleeve parts 146a, 146b then form the complete sleeve 126 without any off-set in the direction of the longitudinal central axis 144 of the sleeve 126.

In order to prevent the two sleeve parts 146a, 146b from moving apart, the ring-shaped element 128 is now pushed onto the outer surface 152 of the sleeve 126 from the threaded-portion end of the sleeve 126.

Hereby, when passing the threaded-portion flange 138 of the sleeve 126, the interior of the ring-shaped element 128 expands when overcoming the resilient restoring force of the ring-shaped element 128 so that the ring-shaped element 128, the internal diameter of which is smaller than the external diameter of the threaded-portion flange 138, can pass the threaded-portion flange 138 of the sleeve 126.

Thereby, the passage of the threaded-portion flange 138 through the ring-shaped element 128 is facilitated by the chamfering of the screw head end portion of the inner wall of the ring-shaped element 128.

After the ring-shaped element 128 has passed the threaded-portion flange 138 of the sleeve 126, the ring-shaped element 128 is pushed further along the longitudinal axis 162 of the screw member 124 towards the screw head 130 until the screw-head-end contact surface 154 thereof rests against the lower surface 156 of the outer screw-head-end flange 140 of the sleeve 126.

The ring-shaped element 128 that has been restored in shape after passing the threaded-portion flange 138 of the sleeve 126 exerts a contact pressure on the outer surface 152 of the sleeve 126 so that the ring-shaped element 128 is held securely in position relative to the sleeve 126 by frictional engagement.

Because the ring-shaped element 128 surrounds the two sleeve parts 146a, 146b, the sleeve parts 146a, 146b can no longer be moved apart in the radial direction so that the two sleeve parts 146a, 146b and hence the sleeve 126 are held captive as a whole on the screw member 124.

Moreover, the ring-shaped element 128 is held on the sleeve 126 by frictional engagement and additionally by the threaded-portion flange 138, which forms an undercut, positively so that the ring-shaped element 128 is also connected to the screw member 124 in captive manner.

In the installed state of the assembly 100 as is illustrated in FIG. 1, the external thread of the threaded portion 132 of the screw member 124 is rotated into the internal thread of the threaded blind hole 108 in the second component 106. The screw member 124 and the sleeve 126 extend through the passage opening 104 to the first component 102.

The sleeve 126 is supported via the resilient ring-shaped element 128 on the first component 102 so that the sleeve 126 and the screw member 124 are vibrationally-decoupled from the first component 102.

Furthermore, due to the elastomer sealing element 114 which is arranged between the first component 102 and the second component 106 and the flange 120 of which laps over the threaded-portion flange 138 of the sleeve 126, there is provided a vibration decoupling means between the two components 102 and 106.

Furthermore, in the assembled state of the combination 122, the outer screw-head-end flange 140 and the inner screw-head-end flange 136 of the sleeve 126 rest against the screw head 130 so that the sleeve 126 simultaneously adopts the function of a washer.

Since, in the assembled state of the combination 122, the sleeve 126 extends up to the threaded portion 132 of the screw member 124 and the internal diameter D′ of the sleeve 126 is only slightly greater than the external diameter D of the threaded portion 132, the longitudinal central axis 144 of the sleeve 126 and the longitudinal axis 162 of the screw member 124 are substantially coaxial in the installed state of the assembly 100.

1. A combination of a screw member comprising a screw head, a threaded portion and a shank portion which is arranged between the screw head and the threaded portion and has an external diameter that is smaller than the external diameter of the threaded portion, and a sleeve which comprises a narrowed section the internal diameter of which is smaller than the external diameter of the threaded portion,
wherein the sleeve is in multipart form at least in the narrowed section thereof, wherein the shank portion of the screw member passes through the narrowed section of the sleeve and wherein the several parts of the sleeve are connected to one another in such a manner that the sleeve is held captive on the screw member.

2. A combination in accordance with claim 1, wherein the sleeve is in two-part form at least in the narrowed section thereof.

3. A combination in accordance with claim 2, wherein each part of the sleeve extends over a peripheral angle of approximately 180°.

4. A combination in accordance with claim 1, wherein the combination further comprises a ring-shaped element which surrounds the several parts of the sleeve.

5. A combination in accordance with claim 4, wherein the ring-shaped element is held on the sleeve in force-locking and/or positive manner.

6. A combination in accordance with claim 4, wherein the ring-shaped element is in the form of a resilient element.

7. A combination in accordance with claim 4, wherein the ring-shaped element comprises an elastomer material.

8. A combination in accordance with claim 1, wherein the screw head end portion of the sleeve has a radially outwardly projecting flange.

9. A combination in accordance with claim 1, wherein the end portion of the sleeve remote from the screw head has a radially outwardly projecting flange.

10. A combination in accordance with claim 1, wherein the sleeve is provided with a radially outwardly projecting flange in the narrowed section thereof.

11. A method of making a combination of a screw member comprising a screw head, a threaded portion and a shank portion which is arranged between the screw head and the threaded portion and has an external diameter that is smaller than the external diameter of the threaded portion, and a sleeve which has a narrowed section the internal diameter of which is smaller than the external diameter of the threaded portion, the method comprising the following steps:
providing a sleeve which is in multipart form at least in the narrowed section thereof;
arranging the several parts of the sleeve on the screw member in such a manner that the shank portion of the screw member passes through the narrowed section of the sleeve;
connecting the several parts of the sleeve to one another in such a manner that the sleeve is held captive on the screw member.

12. A method in accordance with claim 11, wherein a ring-shaped element is pushed onto the sleeve in such a manner that it surrounds the several parts of the sleeve and thereby connects the several parts of the sleeve together and prevents them from moving away from the screw member.
